(19) United States
(12) Patent Application Publication
(10) Pub. No.: US 2005/0289336 A1
(43) Pub. Date: Dec. 29, 2005

(54) METHOD AND APPARATUS FOR SWITCHING AMONG MULTIPLE INITIAL EXECUTION ADDRESSES

(76) Inventors: Yi-Chang Chen, Taipei Hsien (TW); Chih-Hsuan Wu, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/904,577

(22) Filed: Nov. 17, 2004

(30) Foreign Application Priority Data
Jun. 28, 2004 (TW) 93118736

(51) Int. Cl. G06F 15/177

(52) U.S. Cl. 713/2

(57) ABSTRACT

A method and an apparatus for switching among multiple initial execution addresses in computer systems. The purpose is to efficiently select a code segment for initial execution after booting. A switch signal and a reference address are read, and then an initial execution address is picked from several possible addresses based on the switch signal and the reference address. The advantages provided by the present invention are reducing the booting time, independently upgrading BIOS and enhancing competitiveness.

### CROSS-REFERENCE TO RELATED APPLICATION

This application claims the priority benefit of Taiwan application serial no. 93118736, filed Jun. 28, 2004.

### BACKGROUND OF THE INVENTION

1. Field of the Invention

The present invention relates to a method and apparatus for switching among multiple addresses in computer systems, and more particularly, to a method and apparatus for switching among multiple instruction execution addresses in computer systems.

2. Description of Related Art

Currently, the execution addresses of the 80×86 series CPU (Central Processing Unit) are fixed after booting. As shown in FIG. 1, if CPU 101 is an 80286 series CPU, a first executed instruction is fetched from the address F000:FFF0h (wherein “h” indicates it is a hexadecimal number) of the memory 102 after booting. If CPU 101 is an 80386 series CPU, the start instruction is executed from address FFFFFFF0h. In both cases above, the first execution address after booting (referred to as an “initial execution address” hereinafter) is mapped to a start address of the BIOS (Basic Input/Output System). Wherein, the BIOS is generally stored in a non-volatile memory storage device, such as an EEPROM (Electrically Erasable Programmable Read Only Memory) 103 as shown in FIG. 1.

Since the initial execution address is a fixed value, in any case it is intended to select a code segment for initial execution after booting based on some specific conditions. The only way is executing the BIOS execution codes following the flow depicted in FIG. 2. After booting, at step 202, whether or not an expanded boot mode is activated is checked or determined. If it is determined that the expanded boot mode is being activated, the process proceeds to step 204, where a special function provided by the expanded boot mode is executed (e.g. using it as a DVD player). Otherwise, the process proceeds to step 206, where a general boot function is executed (e.g. using it as a general computer).

Since such method uses software to determine the special boot conditions, the whole process is not executed until all pre-processes required by the general boot operation are totally completed. Therefore, the disadvantages of this method are lower speed and dependency due to the fact that the whole set of BIOS has to be updated every time it reboots. The information electrical appliance currently deploys a computer to perform various functions, such as TV, radio, or VCR for playing various media formats. The real requirement is to provide a high level of execution efficiency and convenience. However, because of its lower boot speed and dependency, the method currently used cannot meet the present demand.

Therefore, there is a need to provide a better solution to resolve the current disadvantages mentioned above.

### SUMMARY OF THE INVENTION

Accordingly, the present invention is directed to a method of switching among multiple initial execution addresses. The advantages provided by the method of the present invention are reducing booting time, independent BIOS upgrade and enhancing competitiveness.

The present invention is directed to an apparatus for switching among multiple initial execution addresses. The advantages of the method of the present invention are reducing booting time, independent BIOS upgrade and enhancing competitiveness.

According to an embodiment of the present invention, a switch signal and a reference address are read, and then an initial execution address from multiple possible addresses based on the switch signal and the reference address is selected.

According to another embodiment of the present invention, the apparatus for switching among multiple initial execution addresses is electrically coupled between a CPU and a non-volatile memory where a plurality of boot code segments is stored. The apparatus comprises a boot device for providing a switch signal based on different boot requirements, and a switch device for receiving a reference address provided by the CPU and the switch signal provided by the boot device mentioned above, wherein the content of the reference address can be modified according to the switch signal and the modified reference address can be output as an initial execution address.

Since the method and apparatus provided by the present invention uses hardware rather than the software in determining the special boot conditions, it is possible to pick a code segment for initial execution. The advantages are reducing the booting time, independent BIOS upgrade, and only a portion of the BIOS rather than whole BIOS is required to be updated. Accordingly, its competitiveness will be enhanced.

### BRIEF DESCRIPTION OF THE DRAWINGS

The accompanying drawings are included to provide a further understanding of the invention, and are incorporated in and constitute a part of this specification. The drawings illustrate embodiments of the invention, together with the description, explain the principles of the invention.

FIG. 1 schematically shows a diagram illustrating conventional initial execution addresses.

FIG. 2 schematically shows a flow chart illustrating a conventional process of determining the boot mode.

FIG. 3 schematically shows a diagram illustrating initial execution addresses according to an embodiment of the present invention.

FIG. 4 schematically shows an apparatus for switching among multiple initial execution addresses according to an embodiment of the present invention.

FIG. 5 schematically shows a flow chart illustrating a method for switching among multiple initial execution addresses according to an embodiment of the present invention.

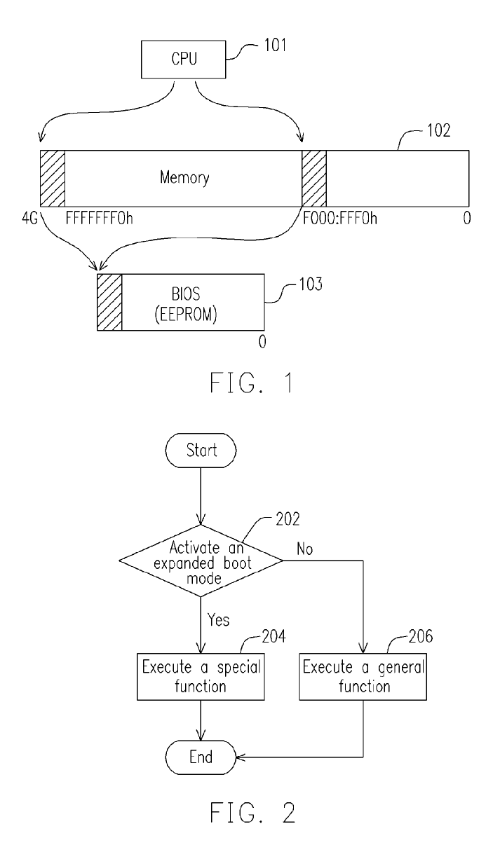

### DESCRIPTION OF EMBODIMENTS

The present invention provides a method and apparatus for switching among multiple initial execution addresses (i.e. the first executed instruction address after booting). The method and apparatus can be applied on the personal computer (PC) and the information electrical appliance that execute different functions after booting in accordance with the special conditions. For example, the DVD player is booted with a fast mode in most common case. However, the DVD player is booted with a debug mode when it is tested in the factory or during maintenance. In addition, if it is intended to deploy a general computer as a DVD player, the boot mode has to be modified. With the method and apparatus provided by the present invention, it would be more convenient in deploying the general computer as an electrical appliance, and the boot speed will significantly improve.

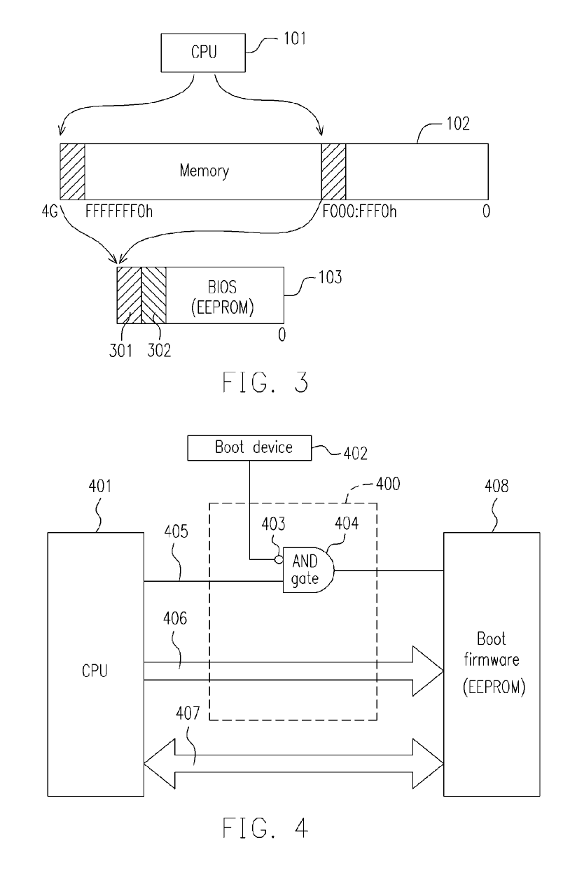

FIG. 3 schematically shows a conceptual diagram of the present invention, and FIG. 3 is roughly the same as FIG. 1. As shown in FIG. 3, a CPU 101, a memory 102, and an EEPROM (Electrically Erasable Programmable Read Only Memory) 103 where the BIOS (Basic Input/Output System) is stored, are provided. As shown in the diagrams, the difference between FIG. 3 and FIG. 1 is that the BIOS of FIG. 3 contains two different boot code segments, namely a first boot code segment 301 and a second boot code segment 302, and one of the boot code segments is selected based on certain special conditions after booting. However, a switch mechanism is required in the real implementation in order to switch it to either the first boot code segment 301 or the second boot code segment 302, whichever corresponds to the initial execution address first. In other words, the initial execution address is switched between these two possible addresses based on the special boot conditions. Therefore, when the BIOS is being updated, only the specific boot code segment is required to be updated, thus a higher level of independence is provided. In addition, in other embodiments, the BIOS may comprise any number of the boot code segments rather than only two boot code segments as shown in FIG. 3.

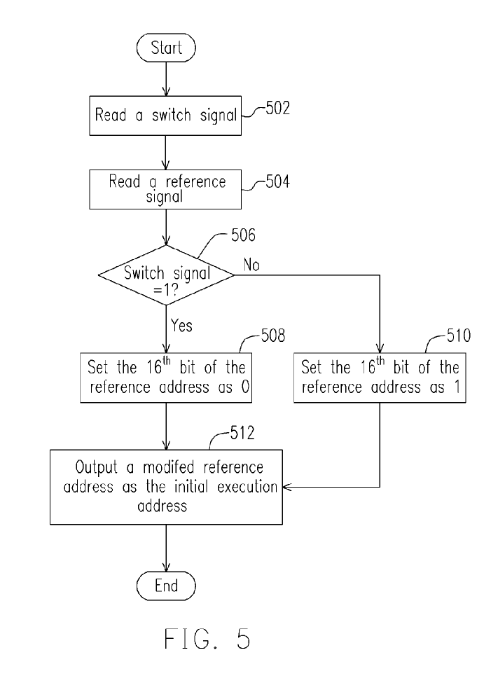

An apparatus for switching among multiple initial execution addresses provided by the present invention is described in detail hereinafter, and FIG. 4 is an exemplary implementation of the apparatus. Wherein, an element 401 is an 80×86 series CPU, and after passing through a switch device 400, address lines 405 and 406 feed an instruction address to be executed by the CPU 401 to an EEPROM 408 where a boot firmware (i.e. BIOS) is stored. Wherein, a 16^{th} address line 405 and other addresses lines 406 are separately marked in FIG. 4 (the reason is provided later). The address lines are marked starting from 0, and the 0^{th} line is the least significant bit. In addition, a data line 407 is configured to transmit data between the CPU 401 and the EEPROM 408.

As shown in FIG. 4, the switch device 400 comprises an AND gate 404 and an inverter 403 which is electrically coupled to one of the input terminals of the AND gate 404. After passing through the inverter 403, a switch signal output from a boot device 402 is fed into the AND gate 404 as its first input, and the 16^{th} address line 405 is the second input of the AND gate 404. The truth table of the AND gate 404 is as below:

| | The 16^{th} address line | The 16^{th} address line |
|---|---|---|
| | 405 is 1 | 405 is 0 |
| Switch signal | 0 | 0 |
| is 1 | | |
| Switch signal | 1 | 0 |
| is 0 | | |

In the present embodiment, the output of the AND gate 404 is the 16^{th} bit of the initial execution address, and the contents in the rest of address lines 406 are output directly. The address provided by the address lines 405 and 406 is a reference address, the switch device 400 modifies the content of the reference address as the output initial execution address based on the reference address and the switch signal. In other words, the switch device 400 modifies the output initial execution address based on the switch signal. In the present embodiment, the boot device 402 outputs different switch signal values with different boot keys. In other words, manufacturers can provide different boot keys to distinguish this computer as a DVD player, a desktop computer or a voice recorder, and the corresponding boot code is provided by the BIOS. Therefore, it is possible to directly execute different boot procedures in order to fulfill various user requirements by using different switch signals generated by pressing different keys.

For example, assuming the reference address is FFFF0000h, if the switch signal is 1, the initial execution address is FFFE0000h; if the switch signal is 0, the initial execution address is FFFF0000h. It is known from comparing these two addresses that the only difference between these two addresses is the 16^{th} bit, and the size of the boot code segment to be switched is limited to 64K. It will be apparent to one of the ordinary skill in the art that the address switching is not necessarily limited to the 16^{th} bit. In the real implementation, it should be tuned to an optimal status based on the size of each boot code and the type of the storage device where the boot codes are stored.

In addition, although there are only two types of variance in the initial execution address in the present embodiment, but the only difference is one bit. In implementation, this calculation may be more complicated and more variable, thus there may be a bigger gap between these two addresses. In other words, the initial execution address may be more versatile and may have more variable.

In addition to the embodiment shown in FIG. 4, if the function of the corresponding address switching can be supported by the system control chip itself, it is possible to directly implement the present apparatus.

A method for switching among multiple initial execution addresses further provided by the present invention is described in detail hereinafter. FIG. 5 schematically shows a flow chart illustrating the method according to an embodiment of the present invention. First, at step 502, a switch signal is read, and at step 504, a reference address is read. And at step 506, it is determined whether or not the value of the switch signal is 1, if it is determined that the value of the switch signal is 1, step 508 is executed, where the 16^{th} bit of the reference address is set as 0. Otherwise, step 510 is executed, where the 16^{th} bit of the reference address is set as 1. Finally, in step 512, the modified reference signal is output as the initial execution address.

The exemplary case for describing the apparatus for switching among multiple initial execution addresses mentioned above applies here as well. Assuming the reference address is FFFF0000h, if the switch signal is 1, the initial execution address is FFFE0000h; if the switch signal is 0, the initial execution address is FFFF0000h.

In the present embodiment, only one bit is used in calculating the initial execution address, and only two possible addresses are available for choosing. In the real implementation, the calculation of the initial execution address may be more complicated and may use more bits, thus the quantity of the possible addresses may be increased when desired.

In summary, the method and apparatus provided by the present invention switches the code segment, which is to be executed in booting, with a switch signal embodied by hardware rather than software. Thus, the present invention is capable of reducing the booting time, independently update BIOS, and only the specific boot code segment need to be updated rather than updating the whole BIOS. Accordingly, the competitiveness is enhanced.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A method for switching among a plurality of initial execution addresses, comprising:
reading a switch signal;
reading a reference address; and
calculating and picking one initial execution address from a plurality of possible addresses according to the switch signal and the reference signal.

2. The method for switching among the plurality of initial execution addresses of claim 1, wherein the switch signal is provided by a boot device.

3. The method for switching among the plurality of initial execution addresses of claim 1, wherein the quantity of the possible addresses is two.

4. The method for switching among the plurality of initial execution addresses of claim 3, wherein the possible addresses are differed in only one bit.

5. The method for switching among the plurality of initial execution addresses of claim 4, wherein:
if the switch signal is 0, the initial execution address is FFFF0000h, and if the switch signal is 1, the initial execution address is FFFE0000h.

6. The method for switching among the plurality of initial execution addresses of claim 1, wherein the reference address is provided by an 80×86 series CPU.

7. The method for switching among the plurality of initial execution addresses of claim 1, wherein the initial execution address corresponds to one of a plurality of boot code segments contained in a boot firmware.

8. The method for switching among the plurality of initial execution addresses of claim 7, wherein the boot firmware is stored in an EEPROM (Electrically Erasable Programmable Read Only Memory).

9. An apparatus for switching among a plurality of initial execution addresses, being electrically coupled between a CPU and a non-volatile memory storing a plurality of boot code segments, the apparatus comprising:
a boot device, for providing a corresponding switch signal based on different boot requirement; and
a switching device, for receiving a reference address provided by the CPU and the switch signal provided by the boot device and outputting a modified reference address as the initial execution address by modifying a content of the reference address according to the switch signal.

10. The apparatus for switching among the plurality of initial execution addresses of claim 9, wherein the switch device further comprises:
an inverter, for receiving the switch signal and outputting an inverse signal of the switch signal; and
a logic gate, for receiving the inverse signal of the switch signal provided by the inverter, performing a logic operation on a first address line of the reference address and the inverse signal, and outputting a second address line of the initial execution address.

11. The apparatus for switching among the plurality of initial execution addresses of claim 10, wherein the logic gate is an AND gate.

12. The apparatus for switching among the plurality of initial execution addresses of claim 10, wherein the first address line is a 16^{th} address line of the reference address, and the second address line is a 16^{th} address line of the initial execution address.
